(19) United States
(12) Patent Application Publication
(10) Pub. No.: US 2004/0191476 A1
(43) Pub. Date: Sep. 30, 2004

(54) Multilayer packaging structure having one or more microperforated layers

(76) Inventors: Fred L. Wallen, Sun Prairie, WI (US); Seth G. Holmen, Ames, IA (US)

Correspondence Address: DEWITT ROSS & STEVENS S.C., 8000 EXCELSIOR DR, SUITE 401, MADISON, WI, 53717-1914, US

(21) Appl. No.: 10/395,481

(22) Filed: Mar. 24, 2003

(51) Int. Cl. B32B 3/10

(52) U.S. Cl. 428/138; 428/137

(57) ABSTRACT

Disclosed is a multilayer, gas-permeable structure. The structure includes a polymeric outer film and a polymeric inner film. The two films are permanently adhered to one another in face-to-face orientation. One of the two films, either the outer film or the inner film, but not both, includes a plurality of perforations passing through it. The perforations in the perforated film define a void volume and the void volume large enough so that the gas-permeability of the perforated film has a zero or an insignificant contribution to the gas permeability of the structure as a whole. The structures are useful for packaging fresh-cut produce and other foods.

### FIELD OF THE INVENTION

The invention is directed to flexible, polymeric, multilayer packaging laminates wherein at least one of the layers of the laminate is microperforated such that the perforated layer(s) do not significantly contribute to the oxygen transport rate of the complete multilayer laminate structure.

### BACKGROUND

The shelf life and attractive appearance of packaged fresh foods, fresh produce in particular, is generally improved by enclosing food in packaging that modifies or controls the atmosphere surrounding the product. Increasing the shelf life of fresh produce is a desirable end for literally everyone involved in the fresh food business, from the farmers, to the wholesalers, to the retailers, and to the ultimate consumer. For example, increasing the shelf life of fresh foods results in lower-priced produce (due to less wastage). It also yields more visually attractive products. It also results in a wider variety of products being available at any given point in the growing season. These benefits inure to the benefit of the consumer as well as the producer. For the wholesale and retail merchants, increased shelf life translates directly into less waste from spoiled produce. Increased shelf life for produce also enables more flexible control of inventory, and more efficient allocation of transportation resources. All of these criteria yield lower bottom-line production costs for the producer, wholesaler, and retailer.

The United States patent literature contains a large number of patents devoted to packaging specifically designed for use with fresh produce. These patents generally describe two similar types of packaging: 1) modified-atmosphere packaging; and 2) controlled-atmosphere packaging. Both terms refer to packaging materials and/or methods that control the ratio of gasses present within the package. In the processed foods area, modified-atmosphere packaging is generally considered a static method for controlling the atmosphere within the package. See, for example, U.S. Pat. No. 6,441,340, issued Aug. 27, 2002, to Varriano-Marston. In modified-atmosphere packaging, air is removed from the packaging and is replaced with a single gas or a mixture of gases. The gas mixture used depends upon the type of product being packaged. Once the package is sealed, the gaseous atmosphere within the sealed package gradually changes throughout the storage period owing to factors such as respiration of the packed product, biochemical changes, and the slow permeation of gases through the container. The term controlled-atmosphere packaging is often used synonymously for modified-atmosphere packaging. Using the term in this fashion, however, is incorrect as it is not possible to control the atmosphere within a package once the package has been sealed. The more proper terms is controlled-atmosphere storage. Controlled-atmosphere storage is a form of bulk storage wherein the concentration of gases initially introduced to modify the atmosphere is actively maintained throughout the period of storage by constant monitoring and regulation.

An empirical measurement widely used to characterize controlled-atmosphere packaging materials is the oxygen transport (or oxygen transmission) rate. The oxygen transfer rate (OTR) of any given material is expressed as cc O₂/m²-day-atmosphere. Several related units of measure are also widely used in the field, such as cc O₂/100 in²/mil thickness of film/24 hours. Another widely employed means of measuring OTR is described in ASTM D3985-81, which yields an OTR measurement having the units of cc O₂/100 in²/24 hours. (In ASTM D3985-81, the thickness of the film tested in not included in the units expressing the OTR.) The CO₂ transmission rate is also an important physical measurement in certain packaging films. The ratio between the CO₂ transmission rate and the OTR is designated the “beta ratio.”

The general trend in fresh produce packaging has been to use packaging having well-characterized OTR's to modify the atmosphere surrounding the packaged food and thereby to preserve produce quality by reducing the aerobic respiration rate, while simultaneously minimizing the amount of anaerobic processes that lead to food spoilage. In short, fresh produce respires. Modified-atmosphere packaging has as its overall goal the establishment within the package of an optimum level of oxygen and carbon dioxide that will reduce the respiration rate of the packaged produce and thereby slow its spoilage.

Modified-atmosphere packaging typically takes the form of multilayer, polymeric laminates. Films such as those described by U.S. Pat. No. 4,879,078, and U.S. Pat. No. 5,322,726, to Dew, are typical. The Dew patent, for example, describes a packaging film that includes a skin layer of a polypropylene/polyethylene co-polymer, a core layer of a co-polymer of ethylene and vinyl acetate, and a sealant layer comprising linear low-density polyethylene. As described by Dew, the resulting laminate has an OTR of between 160 and 375 cc O₂/100 in²/24 hours.

Films made from polymer blends, co-extrusions, and laminates are currently being used for packaging various weights of low-respiring produce items like lettuce and cabbage. These packaging materials are currently used to market the “bag salads” now widely available in supermarkets. These OTRs of these materials, however, are generally too low to preserve the fresh quality of high-respiring produce such as broccoli, and asparagus. As a consequence, additional methods to produce packaging materials to accommodate these higher respiration rate requirements have been developed.

For example, U.S. Pat. Nos. 4,830,863, 4,842,875; 4,879,078; 4,910,032; 4,923,650; 4,923,703; 5,979,653, and 6,376,032 all describe the use of a breathable microporous patch placed over an opening in an impermeable fresh produce container to control the flow of oxygen and carbon dioxide into and out of the container during storage. The patch or film is produced by plastic extrusion and orientation processes, whereby a highly filled, molten plastic is extruded onto a chill roll and then oriented in the machine direction using a series of rolls that decrease the thickness of the web. During orientation, micropores are created in the film at the site of the filler particles. Next, the microporous film must be converted into pressure sensitive adhesive patches or heat-seal coated patches using narrow web printing presses that apply a pattern of adhesive over the microporous web and die-cut the film into individual patches on a roll. These processes make the cost of each patch too expensive for the wide spread use of this technology in the marketplace. In addition, the food packer has to apply the adhesive-coated breathable patch over a hole made in the primary packaging material (bag or lidding film) during the food packaging operation. To do this, the packer must purchase hole-punching and label application equipment to install on each packaging equipment line. These extra steps both increase packaging equipment costs, and reduce packaging speeds. See U.S. Pat. No. 6,441,340.

An alternative to microporous patches for fresh produce packaging materials is microperforated polymeric packaging materials. Here, holes are physically “punched” through the packaging materials. Various methods can be used to microperforate packaging materials, including cold or hot needle mechanical punches, electric spark microperforation, and laser perforation. Mechanical punches are relatively slow and less precise than electric spark or laser methods, but the equipment is far cheaper. Equipment for spark perforation of packaging materials is not practical for most plastic converting operations, because the packaging material must be submerged in either an oil bath or a water bath while the electrical pulses are generated to microperforate the material. Using laser pulses to generate microperforated materials is both practical and efficient, but the capital cost of laser perforation equipment can be prohibitive for smaller converters.

U.S. Pat. No. 5,832,699, to Zobel, describes a method of packaging plant material using perforated polymer films having 10 to 1000 perforations per m², the perforations having a mean diameter of from 40 to 60 microns, but not greater than 100 microns. The Zobel patent describes the various gas transmission rates of his perforated film as follows OTR no greater than 200,000 cc/m²-day-atm, and a mean vapor transmission rate of no greater than 800 g/m²-day-atm.

### SUMMARY OF THE INVENTION

The present invention is drawn to a multilayer, gas-permeable structure. The structure comprises a polymeric outer film and a polymeric inner film. The outer film is permanently adhered in face-to-face orientation with the inner film. One or more adhesive and/or ink layers may optionally be disposed between the inner layer and the outer layer. One of the outer film or the inner film, but not both, includes a plurality of perforations passing through it. That film (the film with the perforations) is called the perforated film. The collective volume of the perforations in the perforated film defines a void volume. In the present invention, the void volume of the plurality of perforations is sufficiently large so that the gas-permeability of the perforated film has a zero or an insignificant contribution to the gas permeability of the structure as a whole. As used herein, the term “insignificant,” as applied gas permeability in general and oxygen transmission rates in particular, denotes that the film in question contributes less than 15% (and preferably less than 10%) to the total gas permeability or oxygen transmission rate of the entire structure. It is still more preferred that the term “insignificant” denotes that the film in question contributes less than 3% (and preferably less than 1%) to the total gas permeability or oxygen transmission rate of the entire structure. In the most preferred embodiment of the present invention, the gas permeability of the structure as a whole is governed entirely by the gas permeability of the non-perforated film.

In the preferred embodiment of the invention, both the inner and outer films are non-porous. It is also preferred that the outer film is the perforated film and the inner film is non-perforated and non-porous. It is, however, within the scope of the invention to have a structure wherein the inner film is perforated and the outer film is not.

In a preferred embodiment of the structure, the outer film is microperforated prior to it being permanently adhered to the inner film. By microperforating the outer film, and then adhering it to an inner film, the overall gas permeability of the structure is entirely, or almost entirely, dependent upon the gas permeability of the inner film. The vice-versa is true if it is the inner film that is perforated and the outer film is non-perforated, in which case the gas permeability of the structure depends entirely, or almost entirely, upon the outer film. In either case, it is preferred that one or the other of the inner or outer films (but not both) be perforated prior to them being adhered together. While this is the preferred means to fabricate the structure, the structure can also be fabricated by adhering the inner film to the outer film, and then introducing microperforations in one of either the inner film or the outer film (but not both). If this fabrication route is chosen, the microperforations are best introduced using laser-based perforation equipment

The invention solves a number of pervasive and continuing problems regarding packaging for food in general, and packaging for fresh-cut produce in particular. Most notably, the gas permeability of the structure disclosed herein is dependent on only one component film of the structure, rather than upon the additive or synergistic gas permeabilities of two or more component films. Thus, as a general proposition, in the past, the OTR of any given film was controlled by one of two means: controlling the inherent OTR of the components of the film, or perforating or introducing pores into the film, which regulated the passage of gases across the film. Attempting to control OTR by adjusting the inherent OTR of the structure components is quite difficult because this quality of any given film is not easy to control. Controlling OTR using pores or perforations that pass through the entire film is problematic because the beta ratio tends toward 1, which limits the viability of such films when packaging certain types of food.

The present invention solves these problems, among others, by utilizing a multilayer film wherein at least one of the layers is perforated (but non-porous) and at least one of the other layers is non-perforated (and non-porous too). This yields a gas-permeable structure wherein OTR can be controlled by varying the inherent OTR of the non-perforated film, but which has very desirable, high OTRs and beta ratios.

### BRIEF DESCRIPTION OF THE DRAWINGS

FIG. 1 is a schematic representation of a first and preferred embodiment of a multilayer, gas-permeable structure according to the present invention.

FIG. 2 is a schematic representation of a second embodiment of a multilayer, gas-permeable structure according to the present invention.

FIG. 3 is a schematic representation of a third embodiment of a multilayer, gas-permeable structure according to the present invention.

FIG. 4 is a schematic representation of a fourth embodiment of a multilayer, gas-permeable structure according to the present invention.

FIG. 5 is a schematic representation of a fifth embodiment of a multilayer, gas-permeable structure according to the present invention.

### DETAILED DESCRIPTION OF THE INVENTION

As used herein, the phrase “gas-permeability” refers to the transport of gases such as oxygen, nitrogen and carbon dioxide across a membrane. Unless otherwise noted, “gas-permeability” refers to all gases in general. “Oxygen transport (or transmission) rate (OTR)” as used herein designates oxygen transport rate as measured by ASTM D3985-81 or any equivalent protocol. See also ASTM F1307-02. “Beta ratio” refers to the ratio of CO₂ transport rate to OTR. ASTM has not promulgated a standard for measuring carbon dioxide transmission rates. However, equipment for measuring overall gas permeability, oxygen transport rates, and carbon dioxide transmission rates are available commercially, such as the equipment made and sold by MOCON, Inc. (Minneapolis, Minn.).

At present, controlling the OTR of a finished packaging laminate structure is dependent upon a trade-off of mutually exclusive characteristics. On one hand, to satisfy package producers, food packers, and the consumers who ultimately purchase the packaged food, the finished structure must be sufficiently hardy and robust to handle the rigors of printing, converting into a suitable package structure, sealing, transporting, and storing the packaged goods. On the other hand, when packaging fresh produce, the finished structure must have a consistent, accurate, and precise OTR so that the packaged food has the optimum shelf life and a prolonged period during which the food is kept fresh appealing in appearance. If the packaging structure is made too robust, it can be handled and processed roughly, but its OTR will often be too low for packaging fresh produce. If the packaging laminate is made to have an optimally high OTR, it is often too delicate to be handled by conventional printing and converting equipment. It also does not hold up well during transport and storage.

Thus, conventional laminates designed to store fresh produce are often formed of two different layers: a first layer to provide mechanical integrity (often referred to as the “primary”) and a second layer to provide heat-sealability and the desirable OTR characteristics (often referred to as the “sealant”). The overall OTR of such laminates therefore depends upon the OTRs of the individual films (the primary film and the sealant film) that make up the laminate. This approach suffers from a significant drawback in that the manufacturers of the primary and sealant films that make up these structures cannot guarantee the OTRs of their films to the precision desired when packaging fresh produce. In short, film manufacturers generally will not guarantee that their films exhibit an OTR range that is within the tightly defined range desired by fresh food packagers.

One way around this problem is to use microperforated or microporous films. As used herein, these two terms explicitly designate different types of films. Micro-perforated films have micron-sized holes (1-350 μm) passing transversely all the way through the film, the holes being formed mechanically after formation of the film itself These holes pass essentially straight through the film, at an angle substantially perpendicular (normal) to the plane of the film. In contrast, as used herein porous (or microporous) films are formed by introducing a filler (conventionally an inorganic filler) into the resin at high concentration. The presence of the filler cause pores to form in the film as it is processed (e.g., as the resin is extruded or calendared to yield the finished film). Thus, in a microporous film, the pores are formed at the simultaneously as the film itself is formed. The pores are interconnected and define a tortuous path across the film. Thus, a porous or microporous film does not have “holes” passing through it in the conventional sense. Rather it is more akin to a sponge, with a huge number of interconnecting pores that allows gas to pass through the film.

The distinction is critical in that perforated films do not require the presence of inorganic fillers. (Although inorganic fillers can be present in a microperforated film, their presence is not required for purposes of making the perforations.) Moreover, in the preferred embodiment of the present invention, both the inner and outer films are non-porous. As the term is used herein, “non-porous” explicitly designates that a film is devoid of inorganic fillers that result in the formation of interconnecting pores that define a passage from one side of the film to the other.

A distinct advantage of using microperforated films is that they can provide very high OTR rates. These rates are very often significantly higher than is achievable by the inherent OTRs of traditional polyolefin materials.

A drawback, however, of packaging materials where the perforations pass through the entire structure is that their beta ratio invariably equals or closely approaches 1.0. As noted earlier, the beta ratio is the ratio of the CO₂ transport rate to the O₂ transport rate. In a film having a beta ratio of 1.0 means that for every molecule of O₂ that is transferred through the film, a molecule of CO₂ is also transferred. By way of comparison, polyolefins without any perforations have beta ratios in the range of from roughly 2.0 to about 6.0. Because the beta ratio places the CO₂ rate is in the numerator, this means that CO₂ transfers 2 to 6 times as much in these films as compared to O₂. Therefore, in non-perforated polyolefin packages, this beta ratio results in a final equilibrium atmosphere that is low in O₂ and relatively low in CO₂. Moreover, because polyolefin films have a beta ratio range there is a corresponding range of CO₂ and O₂ concentrations within any given package. This can be advantageous because fruits and vegetables vary is their resistance to elevated levels of CO₂.

In contrast, the beta ratios of perforated films are essentially 1.0. Thus, the final ratio of CO₂ to O₂ in conventional perforated materials is severely limited. When using packaging materials with a beta ratio of about 1.0, it is impossible to create packaging that will establish an interior atmosphere that is low in both O₂ and CO₂. Thus, it is not currently possible to make modified-atmosphere packaging using microperforated materials, wherein the desired modified atmosphere is both low-O₂ and low-CO₂. For example, using conventional microperforated materials, it is impossible to achieve a low O₂ level (1%-5%) without getting a high level of CO₂ (15% to 20%). Therefore the use of conventional perforated films is limited to produce items that are resistant to high concentrations of CO₂.

Another disadvantage (perhaps only a perceived disadvantage, but perception is reality in the marketplace) is that because microperforated materials undeniably have holes passing through the packaging material (albeit very small holes), there is a perception that these films are more susceptible to contamination. This perceived disadvantage has been considerably exacerbated by unfortunate events wherein food products were intentionally tainted.

The present invention solves these disadvantages by providing a multilayer, gas-permeable structure wherein a plurality of microperforations pass only partially through the structure. In the preferred embodiment, the structure comprises a polymeric outer film and a polymeric inner film. The outer film is permanently adhered in face-to-face orientation with the inner film, using any means now known in the art or developed in the future. One of either the outer film or the inner film, but not both, includes a plurality of perforations passing there through. The film having the perforations in it is designated the perforated film. The plurality of perforations in the perforated film define a void volume and that void volume is sufficiently large so that gas-permeability of the perforated film has a zero or an insignificant contribution to the gas permeability of the structure as a whole.

In the preferred route of fabricating the structure, the film that is to be perforated has the perforations formed in it prior to its being adhered to the non-perforated film. Various known methods can be used to introduce the perforations into one of the inner or outer films. Such conventional and well-known methods include laser perforation, spark perforation, and mechanical punches using hot or cold needles. Laser-based methods are preferred due to their speed and precision. A suitable laser perforation method, as well as a system for fabricating the perforations, is described in U.S. Pat. No. 6,441,340, incorporated herein.

The average diameter of perforations should preferably fall within the range of from about 1 μm to about 350 μm, more preferably from about 30 μm to about 300 μm, and more preferably still from about 70 μm to about 300 μm. It is preferred that the entire plurality of perforations have a roughly uniform size throughout the structure, although this is not required. In the same vein, it is preferred that the perforations be distributed uniformly across the surface of the film, although this is not required. In one embodiment of the invention, the perforations may define a tear strip, to afford easy access to the contents within the package. See FIG. 5. To obtain a void volume that renders the OTR contribution of the perforated film nil or insignificant as compared to the OTR of the entire structure, generally there should be from about 50 to about 10,000 perforations per square meter, depending inversely upon the diameter chosen for the perforations. If perforations of a smaller diameter are used, more perforations per meter are required.

The means by which the inner and outer films are permanently adhered to one another is not overly critical to the invention, so long as the selected method does not occlude the microperforations present in the perforated layer. Conventional and well-known means for sealing two polymeric films together include, for example, adhesive lamination, using a conventional “dry bond” process or using a solventless adhesive lamination. Extrusion lamination can also be used, as well as thermal lamination. All of these processes are well known in the relevant art and will not be described in any further detail.

Both the outer and inner films for use in the present invention are preferably fabricated from homopolymers, copolymers, and/or blends of alpha-monoolefins having from 2 to 10 carbons, and most preferably from 2 to 5 carbons. Thus, for example, the films can be fabricated from polymeric materials (homopolymers, copolymers or blends) of poly(C₁-C₁₀-alkylene), poly(C₁-C₁₀-alkylene terephthalate), poly(C₂-C₁₀-methylene diamine), polystyrene, poly(C₁-C₁₀-alkylene)-vinyl acetate, poly(C₁-C₁₀-alkylene)-methacrylic acid, poly(C₁-C₁₀-alkylene)-vinyl alcohol, and polycarbonate. This list is exemplary and not exclusive. It is generally preferred that the outer layer be the perforated layer and that this outer layer be fabricated from mono- or biaxially-oriented poly(C₂-C₈-alkylene), most preferably polypropylene. It is generally preferred that the inner layer be non-perforated and be fabricated from a co-polymer or polymer blend that is heat-sealable.

Examples of suitable homopolymers that can be used in the present invention, for either the inner or outer layer, include poly(ethylene), poly(propylene), poly(1-butene), poly(3-methyl-1-butene), poly(3-methyl-1-pentene), poly(3-methyl-1-hexene), poly(4-methyl-1-hexene), poly(4,4-dimethyl-1-hexene), and the like.

Suitable copolymers for either the inner or the outer layer that can be used in the present invention include (but are not limited to) ethylene-co-propylene, ethylene-co-1-butene, ethylene-co-1-pentene, ethylene-co-1-hexene, ethylene-co-1-octene, ethylene-co-1-heptene, ethylene-co-1-nonene, ethylene-co-1-decene, and the like.

Examples of other homo- and copolymers that can be used as either the inner or outer films (or both) in the present invention include poly(ethylene terephthalate), poly(butylene terephthalate), poly(C₂-C₆-methylene diamines) (e.g. Nylon), polystyrene, ethylene-vinyl acetate copolymers, ethylene-methacrylic acid copolymers (i.e., ionomers), ethylene-vinyl alcohol copolymers, and polycarbonate.

Examples of blends that can be used in the present invention (for either the inner or outer film) include blends of homopolymers such as those listed hereinabove (e.g., a blend of polyethylene and polypropylene) or blends of a homopolymer and a copolymer (e.g., a blend of polyethylene with ethylene-co-octene copolymer). Blends of two copolymers can also be used (e.g., a blend of ethylene-co-1-octene and ethylene-co-1-butene).

The individual films used within the structure of the present invention may also be metalized, holographic, or diffraction films.

It is preferred that both the inner and outer films be non-porous.

The films, however, may contain any number of conventional additives such as processing aids, antioxidants, colorants, anti-blocking agents, and the like. Thus, for example, the films may contain processing aids such as calcium stearate, zinc stearate, oleic acid, stearic acid, and the like. The films may also include antioxidant stabilizers, such as tetrakis(methylene (3,5-di-t-butyl-4-hydroxyhydrocinnamate))methane, tris (2,4-di-t-butylphenyl)phosphite, dilaurylthio-dipropionate, and N,N′-diphenyl-p-phenylenediamine. The films may include anti-blocking agents, such as diatomaceous earth. The above list of additives is exemplary only.

There are a host of national and international companies that manufacture and market suitable finished films and/or compounding resins for use in the present invention. They include, for example, Superfilm Packaging Films (Gaziantep, Turkey and Dublin, Ohio), Vifan Film Division Americas (Morristown, Tenn. and Lanoraie, QC, Canada), ExxonMobil Chemical Company (Baton Rouge, La.), Applied Extrusion Technology (Atlanta, Ga.), Intermex S.A. (Monterrey, Mexico), DuPont (Wilmington, Del.), Mitsubishi Polyester Film (Greer, S.C.), SKC Global (Hong Kong), GE Plastics (Pittsfield, Mass.), and Honeywell Specialty Materials Division (Morristown, N.J.). Other companies that supply suitable materials for use in the present invention include Pliant Corporation (formerly Huntsman, Schaumburg, Ill.), New England Extrusion, Inc. (Turners Falls, Mass.), Charter Films (Superior, Wis.), and Flex Tech (San Marcos, Tex.).

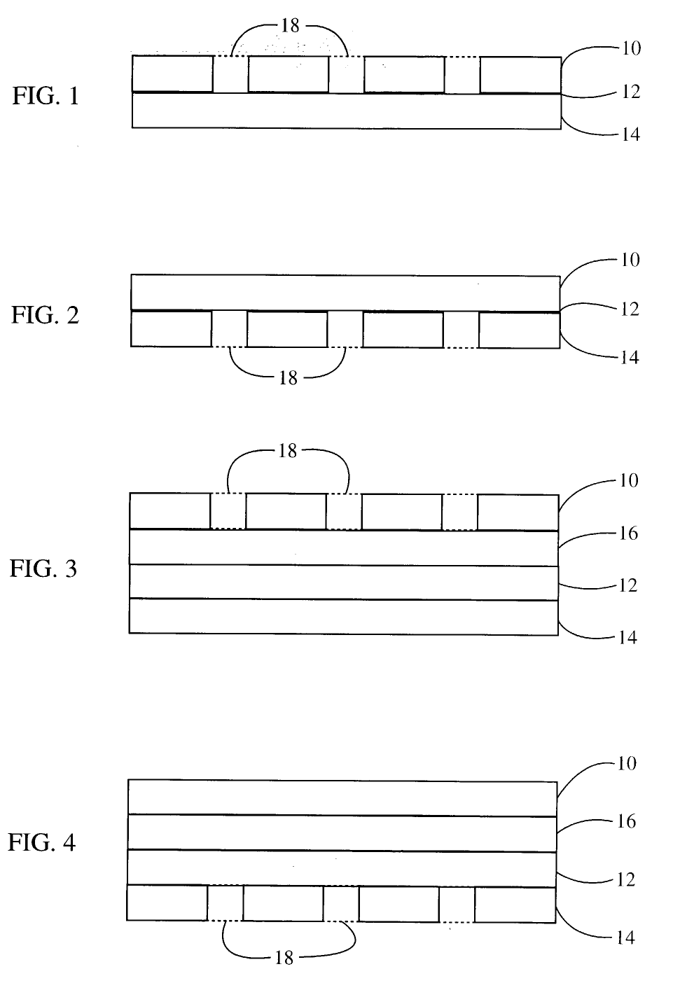

Referring now to the drawing figures, where the reference numerals designate the same elements throughout all of the drawings, FIG. 1 illustrates the preferred embodiment of the invention. Shown schematically in FIG. 1 is a structure according to the present invention, the structure comprising an outer film 10, a permanently adhesive interface 12, and an inner film 14. As shown in FIG. 1, the outer film 10 includes a plurality of perforations 18 passing therethrough. As noted above, the perforations 18 define a void volume that is sufficiently large so that the gas permeability of the structure shown in FIG. 1 is dependent entirely upon the gas permeability of the inner film 14.

FIG. 2 shows another embodiment of the invention, wherein it is the inner film 14 that is perforated. In all other respects, the embodiment shown in FIG. 2 is the same as that shown in FIG. 1.

FIG. 3 shows yet another embodiment of the invention wherein an adhesive layer 12 and an ink layer 16 are disposed between the outer film 10 and the inner film 14. It is preferred, although not required that the adhesive layer 12 be continuous. However, a discontinuous layer 12 is also within the scope of the present invention. The ink layer 16, can be of any color, continuous or discontinuous. The type of ink used in the present invention can be any kind now know or developed in the future for printing on polymeric webs. Conventional inks and printing processes that can be used in the present invention include flexographic printing/ink, lithographic printing/ink and/or rotographic printing/ink. These processes are very well known in the relevant art and will not be described any further. As shown in FIG. 3, the outer film 10 includes a plurality of perforations 18.

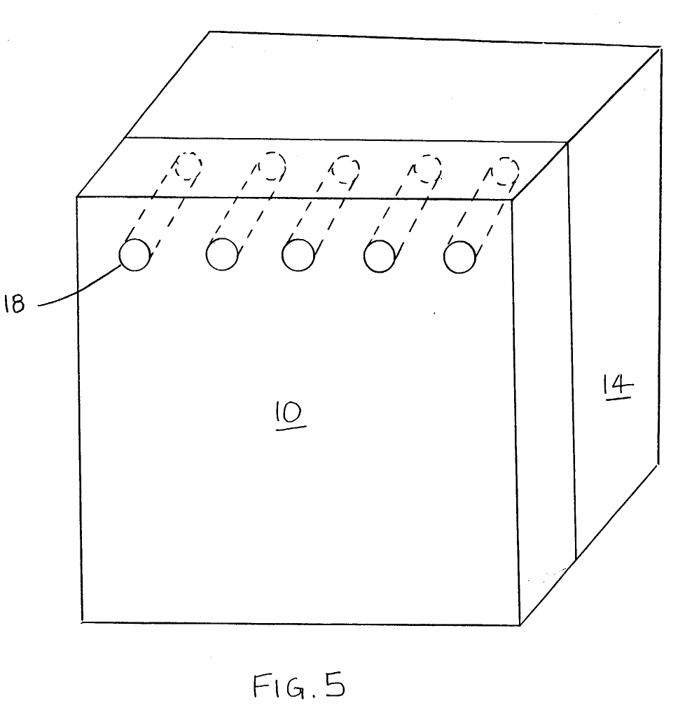

FIG. 4 illustrates a fourth embodiment of the invention wherein the inner film 14 includes a plurality of perforations 18. An adhesive layer 12 and an ink layer 16 are disposed between the outer film 10 and the inner film 14.

Referring to both of FIGS. 3 and 4, the preferred embodiment “buries” the ink layer within the inner and outer films. This is highly desired in the market because then the printed surface is protected against scuffing and flaking during transport and storage. As shown in FIGS. 1 and 2, ink is not a critical aspect of the invention and, if desired, the structures can be printed after the inner and outer films are adhered to on another. It is preferred that the image to appear on the outside of the package be printed in mirror image on the inner face of the outer layer, 10, or in positive orientation on the outer face of the inner layer, 14.

As shown in FIG. 5, the perforations 18 may be disposed in a non-uniform fashion to define a tear strip in the finished packaging. Thus, as shown in FIG. 5, the outer film 10 includes a plurality of perforations 18. The perforations are arranged in a line to define a tear strip—an area of weakened integrity that will tear first when force is applied to the entire structure.

Regarding the calculation of OTR for a multilayer structure, once the OTRs of the individual films are known, the total OTR for lamination can be accurately predicted by the following equation:

OTRₜₒₜₐₗ=1÷(1/OTR_{outer film}+1/OTR_{inner film})

As can be seen from this equation, as the OTR of one of the films gets larger, its contribution to the total OTR gets smaller. In other words, the contribution of the “high-breathing” film (that is, the microperforated film) to the OTR of the entire structure becomes nil or insignificantly small as the OTR of the “high-breathing” film get larger and larger.

In this fashion, the present invention solves to goals of the packaging industry simultaneously: it provides a multilayer structure that is “high-breathing” and thus suitable for use in packaging fresh produce; and it provides a multilayer structure that is physically strong enough to withstand the rigors of conventional packaging machinery, such as integrated VFFS equipment (vertical form, fill, and seal; fin and crimp). In VFFS machinery, the flat packaging structure (normally stored as a web rolled on cores) is formed into a suitable package structure, filled with produce, and sealed, all within the same piece of equipment. In order for this type of equipment to operate at the desired speed, it is critical that the packaging material used by the machinery passes over the various work surfaces (rollers, collars, nip rolls, crimpers, heat-sealing surfaces, etc.) without jamming the works or tearing. In short, every time the machinery must be slowed or stopped due to tears in the packaging material or malformed packages, the productivity of the machinery is decreased.

The structures of the present invention are to be used to make packages. The preferred utility is to use the film in making packages for respirating, fresh-cut vegetables, such as, blueberries, raspberries, cranberries, blackberries, strawberries, carrots, broccoli, spinach, lettuce, cauliflower, blends, and other high respiring products, including other fruits, avocadoes, melons, etc. Fresh cut flowers can also be packaged in the structures disclosed herein.

The present invention has several attributes not found in the prior art. First, as discussed above, the gas permeability of the structure in general, and the OTR in particular, depends entirely, or nearly entirely, upon the OTR of the non-perforated film. This high OTR is achievable without sacrificing the robustness of the finished structure. Insofar as one or the other of the inner or outer films is perforated (microperforated), the nominal thickness of the perforated film is not a factor in the OTR of the structure as a whole. Therefore, a very thick, robust perforated film can be mated to a highly “breathable” non-perforated film, with the result being a highly-breathable, and very strong packaging structure.

What is claimed is:

1. A multilayer, gas-permeable structure comprising:
a polymeric outer film and a polymeric inner film;
wherein the outer film is permanently adhered in face-to-face orientation with the inner film;
wherein one of the outer film or the inner film, but not both, includes a plurality of perforations passing there through, that film being designated the perforated film; and
wherein the plurality of perforations in the perforated film define a void volume, the void volume being sufficiently large such that the perforated film has an oxygen transmission rate that makes a zero or an insignificant contribution to the oxygen transmission rate of the structure as a whole.

2. The structure of claim 1, further comprising an adhesive layer disposed between the outer film and the inner film.

3. The structure of claim 1, further comprising ink disposed between the outer film and the inner film.

4. The structure of claim 1, further comprising an adhesive layer and ink disposed between the outer film and the inner film.

5. The structure of claim 1, wherein the outer film and the inner film are non-porous.

6. The structure of claim 5, wherein the outer film is the perforated film.

7. The structure of claim 5, wherein the inner film is the perforated film.

8. The structure of claim 5, wherein the outer film is the perforated film, and the outer film comprises a polymer, copolymer, or polymer blend selected from the group consisting of poly(C₁-C₁₀-alkylene), poly(C₁-C₁₀-alkylene terephthalate), poly(C₂-C₁₀-methylene diamine), polystyrene, poly(C₁-C₁₀-alkylene)-vinyl acetate, poly(C₁-C₁₀-alkylene)-methacrylic acid, poly(C₁-C₁₀-alkylene)-vinyl alcohol, polycarbonate, copolymers thereof, and blends thereof.

9. The structure of claim 8, wherein the inner film comprises a polymer, copolymer, or polymer blend selected from the group consisting of poly(C₁-C₁₀-alkylene), poly(C₁-C₁₀-alkylene terephthalate), poly(C₂-C₁₀-methylene diamine), polystyrene, poly(C₁-C₁₀-alkylene)-vinyl acetate, poly(C₁-C₁₀-alkylene)-methacrylic acid, poly(C₁-C₁₀-alkylene)-vinyl alcohol, polycarbonate, copolymers thereof, and blends thereof.

10. The structure of claim 9, wherein the inner film is a heat-sealable film.

11. The structure of claim 1, wherein the plurality of perforations in the perforated film has an average diameter of from about 1 μm to about 350 μm.

12. The structure of claim 1, wherein the plurality of perforations in the perforated film has an average diameter of from about 30 μm to about 300 μm.

13. The structure of claim 1, wherein the plurality of perforations in the perforated film has an average diameter of from about 100 μm to about 300 μm.

14. The structure of claim 1, wherein the plurality of perforations passing through the perforated film define a tear strip.

15. A multilayer, gas-permeable structure comprising:
a polymeric outer film and a polymeric inner film;
wherein the outer film is permanently adhered in face-to-face orientation with the inner film;
wherein the outer film comprises a unixially- or biaxially-oriented poly(C₂-C₁₀ alkylene) and further includes a plurality of perforations passing therethrough, that film being designated the perforated film;
wherein the inner film comprises a heat-sealable polymer and further wherein the inner film is devoid of perforations or pores passing therethrough; and
wherein the plurality of perforations in the perforated film define a void volume, the void volume being sufficiently large such that the perforated film has an oxygen transmission rate that makes a zero or an insignificant contribution to the oxygen transmission rate of the structure as a whole.

16. The structure of claim 15, further comprising an adhesive layer disposed between the outer film and the inner film.

17. The structure of claim 15, further comprising ink disposed between the outer film and the inner film.

18. The structure of claim 15, further comprising an adhesive layer and ink disposed between the outer film and the inner film.

19. The structure of claim 15, wherein the inner film comprises a polymer, copolymer, or polymer blend selected from the group consisting of poly(C₁-C₁₀-alkylene), poly(C₁-C₁₀-alkylene terephthalate), poly(C₂-C₁₀-methylene diamine), polystyrene, poly(C₁-C₁₀-alkylene)-vinyl acetate, poly(C₁-C₁₀-alkylene)-methacrylic acid, poly(C₁-C₁₀-alkylene)-vinyl alcohol, polycarbonate, copolymers thereof, and blends thereof.

20. The structure of claim 15, wherein the plurality of perforations in the perforated film has an average diameter of from about 1 μm to about 350 μm.

21. The structure of claim 15, wherein the plurality of perforations in the perforated film has an average diameter of from about 30 μm to about 300 μm.

22. The structure of claim 15, wherein the plurality of perforations in the perforated film has an average diameter of from about 100 μm to about 300 μm.

23. A multilayer, gas-permeable structure comprising:
a polymeric outer film and a polymeric inner film;
wherein the outer film is permanently adhered in face-to-face orientation with the inner film;
an adhesive layer and ink disposed between the outer film and the inner film;
wherein the outer film comprises a unixially- or biaxially-oriented poly(C₂-C₁₀ alkylene) and further includes a plurality of perforations passing therethrough, that film being designated the perforated film;
wherein the inner film comprises a heat-sealable polymer and further wherein the inner film is devoid of perforations or pores passing therethrough; and
wherein the plurality of perforations in the perforated film define a void volume, the void volume being sufficiently large such that the perforated film has an oxygen transmission rate that makes a zero or an insignificant contribution to the oxygen transmission rate of the structure as a whole, and wherein the plurality of perforations in the perforated film has an average diameter of from about 30 μm to about 300 μm.
